(19) United States
(12) Patent Application Publication
(10) Pub. No.: US 2006/0248655 A1
(43) Pub. Date: Nov. 9, 2006

(54) Stainblocker polymers

(76) Inventors: James D. Lambert, Pittsburgh, PA (US); David A. MacEwen, Pittsburgh, PA (US); Lynn Hosie, Pittsburgh, PA (US); Robert Barile, Pittsburgh, PA (US)

Correspondence Address: Lanxess Corporation;Law & Intellectual Property Department, 111 Ridc Park West Drive, Pittsburgh, PA, 15275-1112, US

(21) Appl. No.: 10/549,102

(22) PCT Filed: Mar. 12, 2004
(86) PCT No.: PCT/US04/07763

§ 371 Date: Sep. 13, 2005

(30) Foreign Application Priority Data
Mar. 14, 2003 (US) 60454824

(51) Int. Cl. C11D 3/00

(52) U.S. Cl. 8/115.51

(57) ABSTRACT

Disclosed herein is a composition of matter comprising salts of methylene bridged mixed sulfonated diphenyl oxides and methods of making and using the same.

### BACKGROUND OF THE INVENTION

1. Field of the Invention

The present invention generally relates to stain blocking compositions, which are useful in treating polyamide and or aramid substrates (herein after known collectively as polyamides) and to a process for making and using the same. More specifically, the invention relates to polymers of methylene bridged sulfonated diphenyl oxide which are particularly useful in imparting stain resistance to polyamide fibers.

2. Brief Description of the Prior Art

Polyamide fibers, such as nylon fibers, are useful in producing many different and various textile products. In particular, polyamide fibers are well suited for constructing carpeting. For instance, nylon carpeting is durable, has good aesthetic properties and is relatively inexpensive. Further, nylon carpeting is very receptive to acid dyes and thus can be produced in a wide variety of colors.

Unfortunately, nylon carpeting and other polyamide products are susceptible to staining. For example, many food and beverage items, such as coffee, fruit juices, and wine, contain natural ingredients, which can bind to dye sites located on polyamide materials. Further, many artificial colorants and pigments that are added to food and beverage products can also permanently stain polyamide fibers. Such colorants and pigments are typically added to powdered drink mixes, to gelatin desserts, and to various soft drinks.

In the past, many attempts have been made to make stain resistant polyamide fibers and, in particular, to produce stain resistant carpeting. For instance, in the past, carpet fibers have been coated with liquid resistant coatings, which inhibit wetting of the carpet surface. These coatings, however, have a tendency to wear off over time.

In the past, polyamide carpet fibers have also been treated with stain blocking compositions that actually bind to available dye sites that remain on the fibers after the fibers have been dyed a particular color. For example, various sulfonated novolak resins have been used for this purpose. Novolak resins include syntans, resoles and generally comprise sulfonated phenol and naphthalene formaldehyde condensates. In the past, sulfonated novolak resins have proven to be very effective in providing polyamide materials with stain resistant characteristics. Unfortunately, however, novolak resins have a tendency to discolor when exposed to sunlight or other sources of ultraviolet light. As a result, polyamide materials treated with sulfonated novolak resins, such as carpeting, can yellow or otherwise discolor over time. As such, a need currently exists for an improved stain blocking composition for polyamide materials that binds to available dye sites but does not significantly cause discoloration of the materials after application. Specifically, it would be particularly desirable if a stain blocking agent could be fabricated that would work in conjunction with sulfonated novolak resins in a manner so as to decrease the amount used and hence decrease discoloration when exposed to light.

### SUMMARY OF THE INVENTION

In accordance with the foregoing, the present invention encompasses a stain-blocking polymer derived from multi-components comprising substrates A through F, which are represented by the following general formula 1 and mixed with performance enhancing component(s), G.:

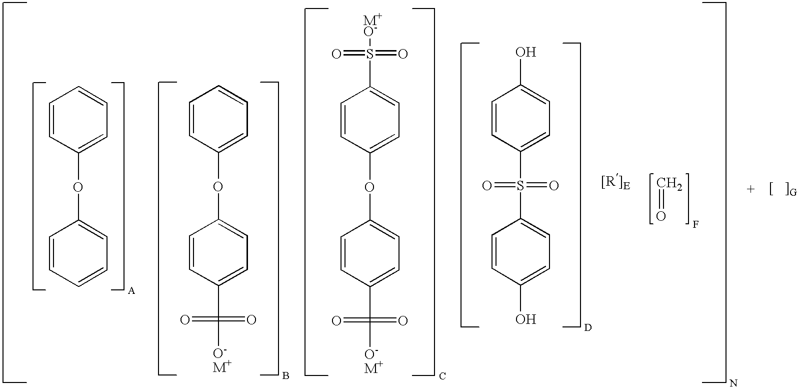

The components are listed as being part of the following groupings: component [A] can be selected from the group consisting of di-aryl or aryl/alkyl ether, [A]; component [B] and [C] are sulfonation products of component [A]; component [D] can be selected from the group of dihydroxy substituted aryl sulfones; component [E] can be a polymer modifier such as -biphenyl or phenol, and component [F] is an aldehyde such as formaldehyde, and solvating components, which are illustratively an acid neutralizing component [M], water and optionally a co-solubilizing alcohol, and/or an additive [G] that synergistically enhance the stainblocking characteristics such as novolak resins, polymers of methacrylic acid, acrylic acid, aspartic acid, their salts or mixtures thereof.

The polymer can be prepared by reacting formaldehyde [F] with an equilibrium mixture comprised of components [A], [B], [C], [D] and [E], in acidic medium to form methylene bridges between the aromatic rings at sites which are typically, but not limited to, those positions, on the ring which are in ortho-positions to the phenolic functional group(s) and those sites in the ortho-position to the R—O—R′ positions of the sulfonated substrate mixture, as described more fully hereunder.

A distinct feature of the invention is the composition of the substrate, [A], or [R—O—R′], the composition of the polymer modifier [E], the composition of the sulfone component [D], the composition of the equilibrium mixture of [A], [B] and [C] formed from the in-situ sulfonation of the substrate [A], the proportion of the sulfone component [D] to the substrate component [A], the proportion of the polymer modifier [E] to the substrate component [A], the proportion of the formaldehyde component [F] to the substrate component [A], the proportion of the performance enhancer(s), [G], the processing times and reaction temperatures, the composition of the acid neutralizing component(s) [M], the composition of the co-solubilizing alcohol(s). [N] represents the degree of polymerization and consequently the molecular weight and molecular weight distribution of the final polymer salt solution. The viscosity is measured either directly with Brookfield (LV) spindles of the reaction mass at 50° C., or, more conveniently by using a Seybolt viscometry tube calibrated to be run at 25° C. with reaction mass samples diluted to 50% (w/w) with an equal proportion of water.

The invention further comprises the process of imparting to polyamide fibers stain resistance to the fibrous polyamide substrates typically by contacting the substrates with the polymer of the claimed invention.

The invention furthermore provides for the polyamide substrates treated with the polymers of the invention such as, but not limited to, nylon, wool, silk, leather and aramid fibers. This and other aspects of the invention are described more fully hereunder.

### DETAILED DESCRIPTION OF THE INVENTION

As set forth above, the present invention relates to a composition comprising salts of methylene bridged mixed sulfonated diphenyl oxides, which are derived from components selected from the group consisting of diaryl or aryl/alkyl ether compounds, [A], sulfonated compound(s) of [A] denoted as [B] and [C], sulfone compound [D], polymer modifier such as phenol or biphenyl, [E], formaldehyde component [F], and solvating components, specifically, but not limited to, an acid neutralizing component [M], water and a co-solubilizing alcohol, as well as, performance enhancer(s), [G].

The substrate, [A], is an ether group represented by the formula R—O—R′ wherein the [R] portion of the ether is comprised of phenyl, naphthalenyl, aryl or alkyl ring structure with at least one, but preferably both ortho-positions with respect to the oxygen atom being free for attachment sites of methylene bridging bonds formed during the formaldehyde polymerization. The [R′] portion of the ether is comprised of phenyl, naphthenyl, aryl or alkyl ring structure with at least one, but preferably both ortho-positions with respect to the oxygen atom being free for attachment sites on the ring.

Illustratively, the ether group can be represented by the formula (II) 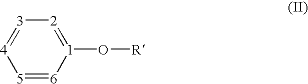
R where ring positions [2] and [6] are preferably un-substituted positions but may contain one substituent group selected from the group consisting of lower substituted or unsubstituted hydrocarbyl group, e.g., an alkyl group containing from (C₁ to C₅), NR₃⁺ (where R represents lower linear or branched substituted or unsubstituted hydrocarbyl group, e.g., an alkyl group containing from C₁ to C₄), nitrate, or cyano group. In a preferred embodiment, both the [2] and [6] ring positions are un-substituted. Ring positions [3] and [5] are preferably un-substituted but may contain one or both positions substituted by a group selected from NH₂, NHR or NR₂ (where R is hydrocarbyl group, e.g., lower linear or branched alkyl containing from C₁ to C₄), OH or OR (where R is a substituted or unsubstituted hydrocarbyl group, e.g., lower linear or branched alkyl containing from C₁ to C₉), ethoxylated adducts containing from 1 to 10 moles of ethylene oxide, propoxylated adducts containing from 1-5 moles of propylene oxide, mixed ethylene/propylene oxide adducts containing from 1 to 10 moles of ethylene or propylene oxide total. In the preferred composition of this invention the ring position [4] is un-substituted but may contain a lower linear or branched substituted or unsubstituted hydrocarbyl group, e.g., an alkyl group containing from (C₁ to C₅), phenyl group, naphthalenyl group, NR₃⁺ (where R denotes lower linear or branched alkyl from C₁ to C₄), nitrate, or cyano.

[R′] can be a substituted or unsubstituted phenyl and preferably an un-substituted phenyl ring optionally having the following substituents: lower linear or branched, alkoxylated adducts selected from the group consisting of ethoxylated adducts containing from 1 to 10 moles of ethylene oxide, propoxylated adducts containing from 1-5 moles of propylene oxide, mixed ethylene/propylene oxide adducts containing from 1 to 10 moles of ethylene or propylene oxide total.

The polymer modifier [E] is interchangeably referred to as [R″] wherein [R″] may be the following compounds, either present as such or in combination with one or more of the compounds selected from the group consisting of: phenol, methoxy benzene, ethoxy benzene, biphenyl, ethoxylated phenol adducts containing from 1 to 10 moles of ethylene oxide, propoxylated adducts containing from 1-5 moles of propylene oxide, mixed ethylene/propylene oxide adducts containing from 1 to 10 moles of ethylene or propylene oxide total, 1,4-Dimethoxybenzene, biphenyl, 1-naphthol, 2-naphthol, 4-cresol, diphenyl oxide, resorcinol, phthalic and terephthalic acid. Without being bound to any particular theory of the invention, it is believed that the polymer modifier is of a nature that provides geometry altering dimension to the final polymer thus enabling it to enhance its stain blocking properties.

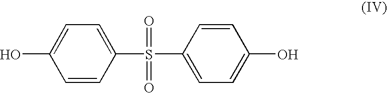

Non-limiting but preferred example of the sulfone component [D] 4,4′-Dihydroxydiphenylsulfone as represented in formula (IV) above, which is commonly referred to as “Diphone A,” but is not limited solely to the 4,4′-isomer. Commercially available sources of the sulfone component [D] have varying amounts of the 4,2′-isomer, generally ranging from 2.0-15.0% of active sulfone percentage, water from 0.5-20.0% of the total mass of the material and inorganic salt(s) ranging from 0.5-10.0% of the total mass. The preferred composition of the sulfone component [D] used in the invention are 80-100% 4,4′-isomer, 0-15% 4,2′-isomer, 0-15% water and 0-10% inorganic salt(s).

In accordance with the invention, the equilibrium mixture comprising unreacted substrate, [A], mono-sulfonated substrate, [B], and di-sulfonated substrate, [C], can be prepared in situ by the treatment of the substrate [A] with concentrated sulfuric acid containing 1-3% water, referred to as “reagent grade” sulfuric acid. The equilibrium mixture can be prepared similarly by conventional methods of sulfonation; i.e., treatment with oleum (20-30% SO₃), or cold sulfonation with SO₃ in a diluent gas (typically Nitrogen). The equilibrium mixture is formed according to the sequence below:

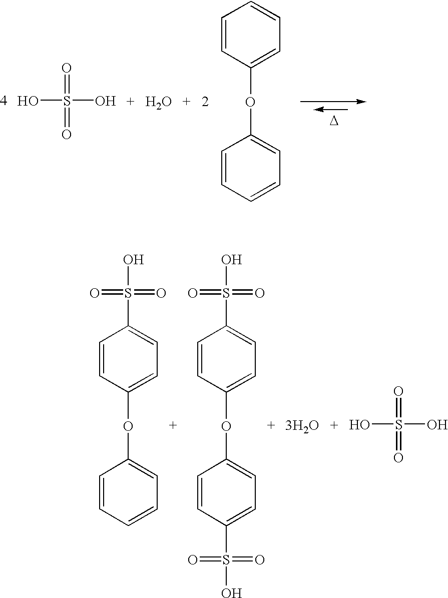

In the preferred embodiment, the equilibrium mixture is prepared by treating the substrate [A], comprising diphenyl oxide with 98% sulfuric acid, in a molar ratio of sulfuric acid to substrate of between 1.20:1.00 to 2.00:1.00, with the preferred molar ratio of sulfuric acid to substrate for the invention being 1.60-1.80:1.00. The mixture of sulfuric acid and substrate [A] is then heated to effectively maximize the conversion of the substrate, [A], to a mixture of mono-sulfonated substrate, [B], di-sulfonated substrate, [C], unreacted substrate, [A], water and unreacted sulfuric acid.

The sulfonation reaction mixture denoted above effectively reaches equilibrium over a period of time, typically between 2.0 to 4.0 hours at reaction temperatures of between 120-145° C. The preferred reaction time for the invention is 2.5-3.0 hours at a preferred reaction temperature of 130-140° C. Preferably, the equilibrium mixture comprises approximately 1.0-4.0% (w/w) water, 1.0-5.0% (w/w) substrate, [A], 4.0-8.0% (w/w) sulfuric acid, 30-50% (w/w) mono-sulfonated substrate, [B] and 30-50% (w/w) di-sulfonated substrate [C] which is effective for use in the polymerization. Preferably, the initial composition of the mixture before reaching the desired equilibrium comprises about 0.0-2.00% (w/w) water, 45-60% (w/w) substrate [A] and 40-50% (w/w) sulfuric acid.

The desired equilibrium mixture comprising approximately 1.0-4.0% (w/w) water, 1.0-5.0% (w/w) substrate, [A], 4.0-8.0% (w/w) sulfuric acid, 40-50% (w/w) mono-sulfonated substrate, [B] and 30-50% (w/w) di-sulfonated substrate, [C], is diluted with water at a temperature below 100° C. The amount of water added to the equilibrium mixture will dictate the relative rate of the polymerization. The effective amount of water added to the equilibrium mixture is from between 25.00 to 150.00% of the total weight of the amounts of substrate, [A], and sulfuric acid used to produce the equilibrium mixture. The amount of water added to the mixture that is the preferred amount to yield a controllable, yet relatively aggressive reaction rate is 60-110% of the total mass of substrate, [A], and sulfuric acid charged during the initial mixing.

The proportion of the sulfone component, [D], added to the amount of initial substrate, [A], charged is that which is effective to substantially alter the composition and performance of the resultant polymer formed from the subsequent reaction of the components of equilibrium mixture comprising the previously described proportions of substrate, [A], mono-sulfonated substrate, [B], and di-sulfonated substrate, [C]. A final polymer with acceptable performance characteristics can be made with a molar ratio of sulfone component, [D], to initial charge of substrate, [A], ( ) of between 0.3:1.000 to 0.9:1.000. The preferred molar ratio of sulfone component, [D], to initial substrate, [A], of 0.45-0.65:1.000 produces a polymer of the invention of the invention.

The proportion of the polymer modifier, [R″], interchangeably referred to as component [E], added to the amount of initial substrate, [A], charged is that which is effective to substantially alter the composition, and performance of the resultant polymer formed from the subsequent reaction of the equilibrium mixture containing the previously described proportions of substrate, [A], mono-sulfonated substrate, [B], di-sulfonated substrate, [C], and proportions of sulfone component [D] and formaldehyde component [F]. A final polymer with acceptable performance characteristics can be made at an acceptable rate with a molar ratio of polymer modifier component, [E], to initial charge of substrate, [A], of up to 0.080:1.000. The preferred molar ratio of polymer modifier component, [E], to initial substrate, [A], of 0.000:1.000 produces a polymer of optimal performance in the final product. The amount of polymer modifier component, [E], up to and including the 0.080:1.000 molar ratio, added to the mixture that is the preferred amount to yield a controllable, yet relatively aggressive reaction rate, is only applicable and effective when the water charge discussed herein is below 50-60% of the total mass of substrate, [A], and sulfuric acid charged during the initial mixing. Illustrative examples of the polymer modifier, [E], can be selected from the group consisting of phenol, biphenyl, 4-methoxybenzene, p-nonylphenol, resorcinol, phthalic and terephthalic acids.

The proportion of the formaldehyde component, [F], added to the amount of initial substrate, [A], charged can alter the composition and performance of the resultant polymer formed from the subsequent reaction of the equilibrium mixture containing the previously described proportions of substrate, [A], mono-sulfonated substrate, [B], and di-sulfonated substrate, [C]. The preferred source of the aldehyde component, [F], is an aqueous solution of formaldehyde containing from 20-40% (w/w) active formaldehyde, 3-10% methanol and the balance water. The polymerization can also use other sources of formaldehyde such as paraformaldehyde, Formcel® or Methaform 55A, but the previously mentioned aqueous formaldehyde solution is the preferred source. A final polymer with acceptable performance characteristics can be made with a molar ratio of formaldehyde component, [F], to initial charge of substrate, [A], of between 1.000:1.000 to 2.00:1.000. The preferred molar ratio of formaldehyde component, [F], to initial substrate, [A], of 1.4-1.6:1.000 produces a polymer of optimal performance in the final product.

Once the additions of the initial water charge, sulfone component, [D], with or without the addition of the polymer modifier component, [E], are affected, the resultant mixture is then cooled to below the boiling point of formaldehyde. The formaldehyde component, [F], is then added, and heating begins. The heating rate is controlled so that the reaction mass is heated at a rate of between 0.7 to 1.5° C. per minute with the preferred rate of heating as close to 1.0° C. per minute as possible. The reaction mixture is then heated up to from between 80-110° C. and held until the polymer formed is observed to be a visibly thick plasticine mass. The progress of the polymerization is conveniently measured by sampling the reaction mass, cooling the sample to 50° C., and measuring the viscosity on a Brookfield-type viscometer, or by using a 50% solution of the polymer reaction mass in water with a Seybolt tube calibrated at 25° C. The optimal in-process Seybolt viscosity measurement yielding a final diluted polymer salt solution with excellent stain-blocking properties is observed to be in the range of from 4.02 to 30.00 SUS measured at 25° C.

The time to effect adequate polymerization, as evidenced by in-process viscometry measurements, will obviously vary as a function of the amount(s) and composition(s) of the substrate, [A], resultant equilibrium sulfonation mixture of un-reacted substrate, [A], mono-sulfonated substrate, [B], di-sulfonated substrate, [C], residual sulfuric acid, total water present, sulfone component, [D], polymer modifier component, [E], and aldehyde component, [F], but is generally observed to occur from between 3 to 12 hours after reaching the reaction temperature. The preferred time of reaction is seen to typically be from between 4-8 hours at an optimal temperature of 98-105° C., given the preferred composition delineated in the preceding text. Given the descriptions herein, it would be within the purview of the skilled artisan to employ equivalents of the reactants and reaction conditions in order to produce the polymers in accordance with the invention. The resulting polymer can have weight average molecular weight ranging from about 1000 to about a million. Typically molecular weight in the range of about 1600 to 100,000 are employed.

The reaction mixture is then diluted with a final water charge and cooled to a temperature below 95° C. and neutralized to form water-soluble salts of the sulfonated polymer and residual sulfuric acid present. The neutralization is affected by the addition of a cation [Mⁿ⁺] hydroxide, oxide, carbonate, hydrogen carbonate, phosphate, monocarbamide dihydrogen sulfate, hydrogen phosphate, di-hydrogen phosphate, sulfamate or an amine. The composition of the cation [Mⁿ⁺] can be a group 1A or 2A cation, a transition metal ion such as Mn²⁺, Fe³⁺, Al³⁺, Cu²+, and Zn²⁺. The composition of the amine is a primary or secondary amine of general formula R—NH₂ or R—NR′H where R and/or R′ may be a linear or branched lower alkyl from C₁ to C₅, cyclo-alkyl from C₁ to C₆, aromatic from C₆ to C₁₂, or mixtures of the former.

Once the aqueous solution of the polymer salt has been formed, a small amount of a co-solubilizing alcohol is added to give the final product enhanced thermal stability to cold temperatures. The alcohol concentration in the final aqueous solution is between 1.0-8.0% (w/w) of the total solution weight but the preferred concentration for the invention is 1.23% (w/w). The composition of the alcohol represented as R—OH is selected from primary or secondary linear or branched lower alkyl from C₁ to C₆; glycols and poly-ethoxylated glycol ethers from 1 to 5 ethylene oxide repeat units in length.

The stainblocking composition of the invention can be applied to dyed or undyed natural and synthetic polyamide fibers such as, but not limited to, nylon, wool, silk, leather, aramid and blends thereof. The stain blocking composition can be applied by any of the methods known to those skilled in the art, such as, but not limited to, exhaust, pad, flood, spray, foam, kiss, or print procedure in either batch or continuous modes. The composition can be applied to the polyamide fiber in combination with a soil and water repellent fluorocarbon or it can be applied alone. The stainblocking polymer composition provides excellent protection against Food, Drug and Cosmetic Red Dye No. 40 (Red dye No. 40) applied via a solution at room temperature for 24 hours (MTCC Method 175-1998) or after 1 minute with a solution at 140° F. The stainblocking polymer composition represents a significant improvement in stain blocking technology in that it requires lower solids based on the weight of the polyamide fiber to attain effective stain blocking. For example polymer compositions having solids content of 15% to 40% and preferably 20% to 36% can be employed in accordance with this invention. Also the stainblocking polymer of this invention can be used in combination with other polymers such as novolak resins or acrylic, methacrylic or aspartic acid polymers, or sodium salts thereof. A combination of this new stainblocking polymer with novolak resins affords excellent stainblocking at much lower solids due to a synergistic effect. Illustratively, a combination containing from about 5-15% to 3-10% and preferably—10-15% to 3-5% of stainblocking polymers to Novolak resins can be employed. Illustratively, a combination containing from about 10-30% to 2-15% and preferably 15-28% to 2-7% of stainblocking polymers to acrylic resins can be employed. A further advantage of the polymer composition is the improvement in lightfastness over similar formaldehyde condensation products such as novolak resins.

### EXAMPLES

1. To a 1000 ml three-neck round bottom flask 44 gm of diphenyl oxide were charged and then warmed to 45-50° C. To this were added 36 gm of concentrated sulfuric acid with constant stirring with a mechanical agitator. The mixture was allowed to exotherm to ca. 90° C. and was then heated with an electric heat source to 135-140° C. and held for 2.5 hours to complete the sulfonation. The solution was then cooled to ca. 95° C. via external air-cooling to produce a thick homogeneous mass. To this was added 68 gm water and 40 gm 4,4′-Dihydroxydiphenyl sulfone. The resultant heterogeneous reaction mass was then heated to 55-60° C. A total of 26 gm 37% formaldehyde solution was then added. The reactor was affixed with a chilled glycol water condenser and then heated to 95-105° C. and held to initiate polymerization. After 3 hours at 95-105° C. the reaction mass became visibly thick and 43 gm water were added. The reaction mass was then cooled with external air to 70° C. A total of 39 gm of 50% NaOH solution were added to neutralize all free acid keeping the temperature between 70-80° C. during the addition. A second water charge of 92 gm was added to dilute the product. A charge of 6 gm Isopropanol and 17 gm water were added to form the final product.
   Method of Application of Stain Blocking Composition

At least 0.2% solids of the stain blocking polymer based on the weight of the fiber is added to a pad bath. The pH is adjusted to pH 1.8-2.5 with an acid such as citric, sulfamic, acetic, phosphoric, hydrochloric, sulfuric or formic acid before or after the addition of the stainblocking polymer. Magnesium chloride is added to the bath at a concentration of 0-8 g/L. Nylon carpet is added to achieve a wet pick up of 300-400%. The stainblocking polymer composition is fixed by steaming the carpet for 2 minutes. The carpet is then cold rinsed and dried.

Stainblocking is demonstrated with a solution of (Red Dye No. 40) after treatment of the fiber for 1 minute at 140° F. Staining is rated by MTCC Red 40 Stain Scale on a scale of 1-10, where 10 indicates no staining.

Light fastness of the fibers treated with the stainblocking polymer composition is tested by exposing the treated fibers to 40 standard fade units of Xenon light and then graded in accordance to the AATCC Gray scale for lightfastness breaks. The scale is from 1-5 where 5 indicates no change in color.

Stainblocking Results

| | Dosage | | Light Fastness |
|---|---|---|---|
| Nylon Carpet Type | % owf | Stain | (40 hrs) |
| Undyed, type 6 | 1.92 | 9 | 4.5 |
| Undyed, Type 6 | 3 | 10 | 4 |

2. To a 3000 ml three-neck round bottom flask were charged 477 gm of diphenyl oxide and sulfuric acid mixture that had been pre-heated to sulfonate the diphenyl oxide as in example number 1 above. The mixture had been pre-warmed to 45-50° C. The solution was then cooled to ca. 95° C. via external air-cooling to produce a thick homogeneous mass. To this was added 259 gm water and 237 gm 4,4′-Dihydroxydiphenyl sulfone. The resultant heterogeneous reaction mass was then heated to 55-60° C. A total of 179 gm 37% formaldehyde solution was then added. The reactor was affixed with a chilled glycol water condenser and then heated to 95-105° C. and held to initiate polymerization. After 5 hours at 95-105° C. the reaction mass became visibly thick, having a viscosity of at least 100,000 cPs@50° C. A total of 1063 gm water was then added. The reaction mass was then cooled with external air to 70° C. A total of 233 gm of 50% NaOH solution were added to neutralize all free acid keeping the temperature between 70-80° C. during the addition. A charge of 36 gm Isopropanol was added to form the final product.

| | Dosage | | Light Fastness |
|---|---|---|---|
| Nylon Carpet Type | % owf | Stain | (40 hrs) |
| Undyed, type 6 | 2.8 | 9 | 4 |
| Undyed, Type 6 | 1.68 | 9 | 4 |

3. To a 3000 ml three-neck round bottom flask were charged 341 gm of diphenyl oxide and sulfuric acid mixture that had been pre-heated to sulfonate the diphenyl oxide as in example number 1 above. The mixture had been pre-warmed to 45-50° C. The solution was then cooled to ca. 95° C. via external air-cooling to produce a thick homogeneous mass. To this was added 213 gm water, 9 gm biphenyl and 170 gm 4,4′-Dihydroxydiphenyl sulfone. The resultant heterogeneous reaction mass was then heated to 55-60° C. A total of 136 gm 37% formaldehyde solution was then added. The reactor was affixed with a chilled glycol water condenser and then heated to 95-105° C. and held to initiate polymerization. After 6.5 hours at 95-105° C. the reaction mass became visibly thick, having a viscosity of at least 1,000,000 cPs@50° C. A total of 615 gm water was then added. The reaction mass was then cooled with external air to 70° C. A total of 139 gm of 50% NaOH solution were added to neutralize all free acid keeping the temperature between 70-80° C. during the addition. A charge of 26 gm Isopropanol was added to form the final product.

| | Dosage | | Light Fastness |
|---|---|---|---|
| Nylon Carpet Type | % owf | Stain | (40 hrs) |
| Undyed, type 6 | 1 | 8 | 4.5 |
| Undyed, type 6 | 1.5 | 9 | 4 |
| Undyed, Type 6 | 2 | 10 | 3.5 |

4. To a 1000 ml three-neck round bottom flask 86 gm of diphenyl oxide were charged and then warmed to 45-50° C. To this were added 86 gm of concentrated sulfuric acid with constant stirring with a mechanical agitator. The mixture was allowed to exotherm to ca. 90° C. and was then heated with an electric heat source to 135-140° C. and held for 2.00 hours to complete the sulfonation. The solution was then cooled to ca. 95° C. via external air-cooling to produce a thick homogeneous mass. To this was added 123 gm water and 79 gm 4,4′-Dihydroxydiphenyl sulfone. The resultant heterogeneous reaction mass was then heated to 55-60° C. A total of 62 gm 37% formaldehyde solution was then added. The reactor was affixed with a chilled glycol water condenser and then heated to 95-105° C. and held to initiate polymerization. After 5 to 6 hours at 95-105° C. the reaction mass became visibly thick, having a viscosity of at least 100,000 cPs @ 50° C. A total of 279 gm water was then added. The reaction mass was then cooled with external air to 70° C. A total of 89 gm of 50% NaOH solution were added to neutralize all free acid keeping the temperature between 70-80° C. during the addition. A charge of 10 gm Isopropanol was added to form the final product.

| | Dosage | | Light Fastness |
|---|---|---|---|
| Nylon Carpet Type | % owf | Stain | (40 hrs) |
| Undyed, type 6 | 1.2 | 9 | 4 |
| Undyed, type 6 | 1.68 | 9.5 | 4 |

5. Blends of example 4 with lower molecular weight, commercially available novolak resins increase stainblocking at relatively lower doses. To 55 parts water, was added 35 parts example 4 and 10 parts of Shield SP40 (40% by weight solution of condensation of phenyl sulfonate with 4,4′ dihydroxybiphenylsulfone and formaldehyde). The mixture was stirred at room temperature for 15 minutes. The mixture was applied to undyed nylon type 6 carpet as described in example 1. The performance was compared to a standard novolak resin on the same carpet.

| | Polymer | | |
|---|---|---|---|
| Stainblocking | solids | | Light Fastness |
| composition | % owf | Stain | (40 hrs) |
| Example 5 | 0.6 | 10 | 3.5 |
| Arrowshield COL | 0.88 | 10 | 2.5 |

6. Blends of example 5 with polymers such as polymethacrylate further improve lightfastness. To 90 parts sample 5, was added 10 parts. Cinsperse PMA-25, a 25% solution of methacrylic acid polymer from Stockhausen. The pH of the mixture was adjusted to pH 8-9 and stirred at room temperature for 15 minutes. The mixture was applied to undyed nylon type 6 carpet as described in example 1.

| | Polymer | | |
|---|---|---|---|
| Stainblocking | solids | | Light Fastness |
| composition | % owf | Stain | (40 hrs) |
| Example 5 | 0.63 | 10 | 3 |
| Example 6 | 0.63 | 10 | 3.5 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composition of matter comprising salts of methylene bridged mixed sulfonated diphenyl oxides.

2. The composition of claim 1, which is derived from components comprising: a diaryl or aryl/alkyl ether [A], sulfonated compound [B], [C], sulfone compound [D], polymer modifier such as [E], formaldehyde component [F], and a performance enhancer [G], and solvating component(s); specifically, but not limited to, an acid neutralizing component [M], water and a co-solubilizing alcohol.

3. A composition of matter comprising a reaction product of:
(i) diphenyl oxide
(ii) concentrated sulfuric acid
(iii) water
(iv) 4,4′-Dihydroxydiphenyl sulfone
(v) formaldehyde solution
(vi) 50% NaOH solution
(vii) Isopropanol and
(viii) water.

4. A composition of matter comprising a reaction product of:
(i) diphenyl oxide
(ii) polymer modifier biphenyl
(iii) concentrated sulfuric acid
(iv) water
(v) 4,4′-Dihydroxydiphenyl sulfone formaldehyde solution
(vi) 50% NaOH solution
(vii) Isopropanol and
(viii) water.

5. A composition of matter according to claim 3 comprising the addition of the following performance enhancers:
(i) novolak resins
(ii) polymethacrylic acid and sodium salts thereof
(iii) Polyacrylic acid and sodium salts thereof
(iv) Copolymers of polymethacryic and acrylic acids, the sodium salts or blends thereof.
(v) Sulfonated styrene maleic anhydride polymers
(vi) Polymers of aspartic acid

6. A process for preparing a composition of matter comprising:
(i) reacting diphenyl oxide with concentrated sulfuric acid under conditions effective for sulfonation
(ii) adding 4,4′-Dihydroxydiphenyl sulfone to the reaction product
(iii) adding 37% formaldehyde solution wt,as then added under conditions that are effective for polymerization
(iv) adding water to the polymerization product and
(v) neutralizing with 50% NaOH solution,
(vi) adding isopropanol and water.

7. A process of imparting to polyamide fibers stain resistance to the fibrous polyamide substrates comprising contacting the substrates with the polymer as recited in claim 1.

8. The polyamide fiber as recited in claim 7 which is selected from:
(i) nylon
(ii) wool
(iii) silk
(iv) and blends thereof, and
(v) leather
(vi) Aramid.

9. A process of imparting to polyamide fibers stain resistance to the fibrous polyamide substrates comprising contacting the substrates with the polymer as recited in claim 3.

10. The polyamide fiber as recited in claim 9 which is selected from:
(i) nylon
(ii) wool
(iii) silk
(iv) and blends of nylon, wool and silk
(v) leather
(vi) aramid.

11. A process of imparting to polyamide fibers stain resistance to the fibrous polyamide substrates comprising contacting the substrates with the polymer as recited in claim 4.

12. The polyamide fiber as recited in claim 11 which is selected from:
(i) nylon
(ii) wool
(iii) silk
(iv) blends of nylon, wool and silk, and
(v) leather
(vi) aramid.

13. Polyamide substrates treated with the polymers as recited in claim 1.

14. The polyamide of claim 13 which is selected from the group consisting of:
(i) nylon
(ii) wool
(iii) silk
(iv) and blends of nylon, wool and silk, and
(v) leather
(vi) aramid.

15. Polyamide substrates treated with the polymers as recited in claim 3.

16. The polyamide of claim 15 which is selected from:
(i) nylon
(ii) wool
(iii) silk
(iv) and blends thereof
(v) leather
(vi) aramid.

17. Polyamide substrates treated with the polymers as recited in claim 4.

18. The polyamide of claim 17 is selected from:
(I) nylon
(ii) wool
(iii) silk
(iv) blends of nylon, wool and silk, and
(v) leather
(vi) aramid.

19. Polyamide substrates treated with the polymers as recited in claim 5.

20. The polyamide of claim 19 is selected from:
(I) nylon
(ii) wool
(iii) silk
(iv) blends of nylon, wool and silk, and
(v) leather
(vi) aramid.
